(19) United States
(12) Patent Application Publication
(10) Pub. No.: US 2010/0098323 A1
(43) Pub. Date: Apr. 22, 2010

(54) Method and Apparatus for Determining 3D Shapes of Objects

(76) Inventors: Amit K. Agrawal, Somerville, MA (US); Ramesh Raskar, Cambridge, MA (US); Douglas Robert Lanman, Somerville, MA (US); Gabriel Taubin, Providence, RI (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/175,883

(22) Filed: Jul. 18, 2008

(51) Int. Cl. G06K 9/00; F21V 11/00

(52) U.S. Cl. 382/154; 362/355

(57) ABSTRACT

An apparatus and method determine a 3D shape of an object in a scene. The object is illuminated to cast multiple silhouettes on a diffusing screen coplanar and in close proximity to a mask. A single image acquired of the diffusing screen is partitioned into subview according to the silhouettes. A visual hull of the object is then constructed according to isosurfaces of the binary images to approximate the 3D shape of the object.

### FIELD OF THE INVENTION

This invention relates generally to acquiring images of objects, and more particularly to determining a 3D shape of an object from a single image.

### BACKGROUND OF THE INVENTION

Light Fields

A light field is a function that describes light traveling in every direction through every point in a space. The light field can be acquired by a pinhole camera array, prisms and lenses, a plentopic camera with a lenslet array, or a heterodyne camera, where the lenslet array is replaced by an attenuating mask.

Coded-Aperture Imaging

In astronomical and medical imaging, a coded aperture is used to acquire x-rays and gamma rays. High-frequency attenuating patterns can separate the effects of global and direct illumination, estimate intensity and depth from defocused images, and minimize effects of glare.

Silhouettes

When an object in a scene is illuminated by a point light source, the shadow that is cast forms an outline or silhouette of the object. Herein, the terms shadow and silhouette are used interchangeably. As used herein, Analysis of silhouette is important for a number of computer vision applications. One method uses an integral involving illumination and reflectance properties of surfaces and visibility constraints. Silhouettes can be analyzed by Fourier basis functions.

Visual Hulls

Up to now, visual hull have generally been generated from multiple images. Visual hulls approximate the 3D shape an object without performing any feature matching. However, visual hulls are highly-sensitive to camera calibration errors. This sensitivity becomes increasingly apparent as the number of images increases, resulting in poor-quality models. One method avoids this problem by acquiring multiple images of an object with a stationary camera while the object rotates.

It is desired to generate a visual hull from a image acquired of an object in a scene.

### SUMMARY OF THE INVENTION

An apparatus and method determine a 3D shape of an object in a scene. The object is illuminated by multiple light sources so that multiple silhouettes are visible on a pinhole mask and diffusing screen coplanar and in close proximity behind the mask. A single image acquired of the diffusing screen is partitioned into subviews according to the silhouettes. That is, each subview includes one silhouette, and each subview is segmented to obtain a corresponding binary image of the silhouette. A visual hull of the object is then constructed according to isosurfaces of the silhouettes in the binary images to approximate a shape of the object.

### BRIEF DESCRIPTION OF THE DRAWINGS

FIG. 1 is a schematic of a system for determining a 3D pose of an object according to embodiments of the invention;

FIG. 2 is a schematic of a light field parameterization using two planes according to embodiments of the invention;

FIG. 3 is a schematic of occlusion functions at the planes of FIG. 2 according to embodiments of the invention;

FIG. 4 is a schematic of shadow functions corresponding to the shield fields for various occluder configurations according to embodiments of the invention;

FIG. 5 is a schematic of an approximation of a complex occluder decomposed as two parallel and Coincident planes according to embodiments of the invention;

FIG. 6 is a schematic of example masking patterns at various resolutions according to embodiments of the invention;

FIG. 7 is a graph comparing mean transmission as a function of angular resolution for the various patterns of FIG. 6 according to embodiments of the invention; and

FIG. 8 is a flow diagram for generating a visual hull according to embodiments of the invention.

### DETAILED DESCRIPTION OF THE PREFERRED EMBODIMENTS

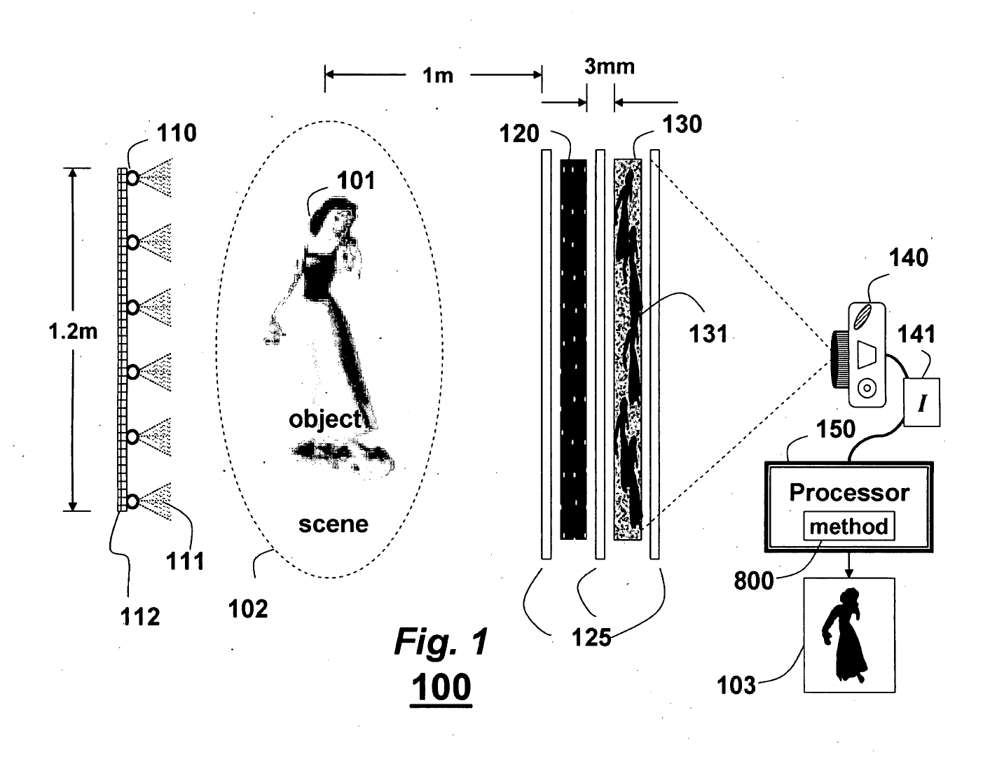

FIG. 1 schematically shows a shield field camera system 100 for determining a 3D shape 103 of an object 101 in a scene 102 according to embodiments of our invention. A visual hull constructed from the single image approximates the 3D shape of the object.

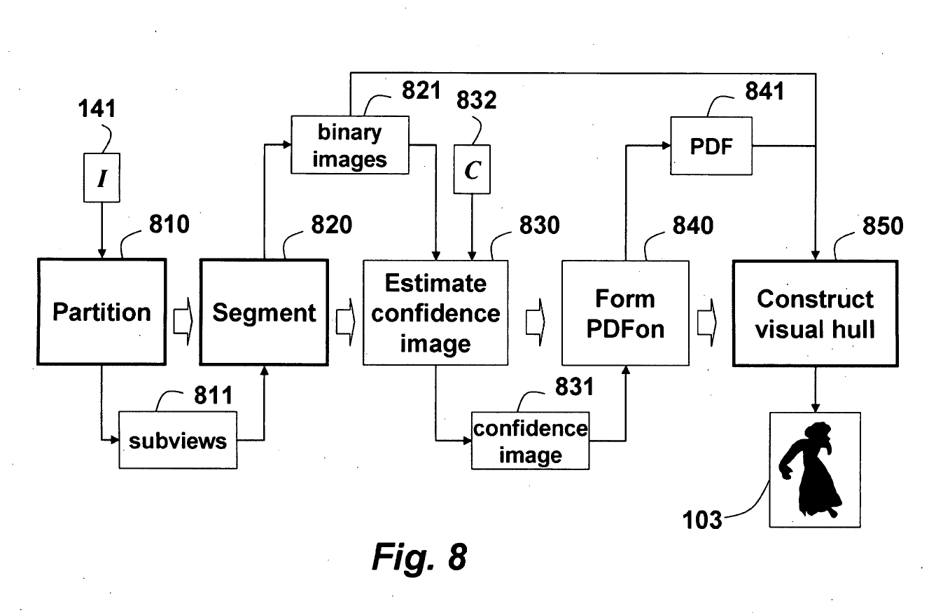

As defined herein, the visual hull 103 is a geometric model generated by our shape-from-silhouette 3D reconstruction method 800, see FIG. 8. The silhouette is the 2D projection or shadow of the 3D object onto an image plane. The image can be segmented into a foreground and background binary image. The foreground or silhouette is the 2D projection of the corresponding 3D foreground object. Along with the camera viewing parameters, the silhouette defines a back-projected generalized cone that contains the actual object.

The system includes an illumination source 110, an attenuating mask 120, a diffuser screen 130, and a sensor 140.

The illumination source 110 can be a large light box or a set of point light sources 111. For example, the set includes a 6×6 array of point light sources uniformly on a 1.2 m×1.2 in scaffold 112. Each point light source is a 3 mm LED producing 180 lumens at 700 mA.

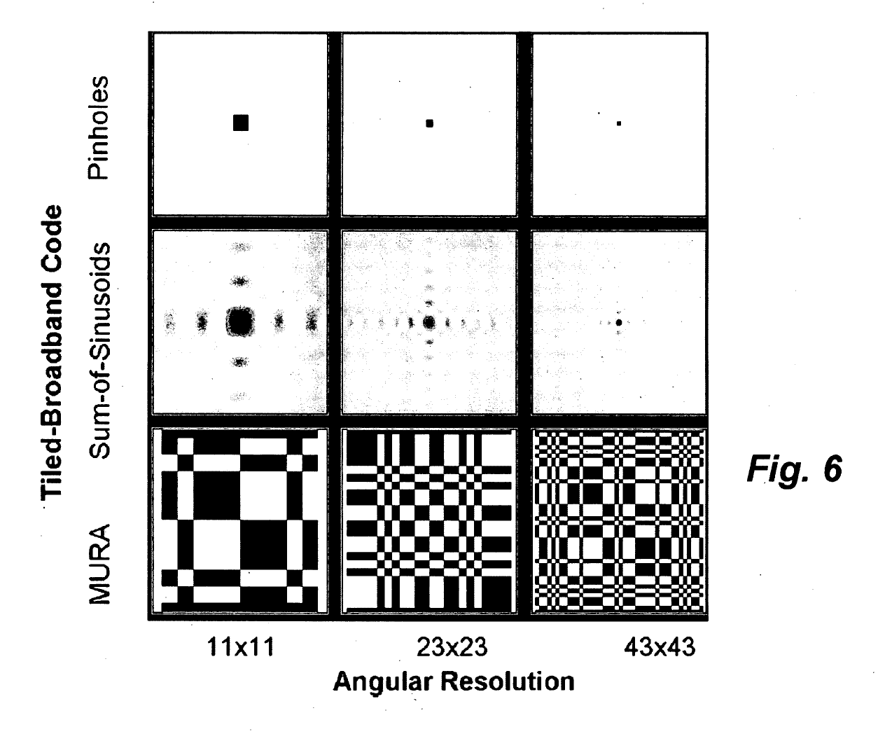

The mask 120 is printed at, e.g., 5,080 DPI, on a 100 μm polyester base using an emulsion printer. The distance between the object source and the mask is about one meter. A number of possible patterns for the mask are described below, including pinhole patterns, sum-of-sinusoidal (SoS) heterodyne patterns, and binary broadband patterns, such as modified uniformly redundant array (MURA) codes, see FIG. 6.

The diffusing screen is placed behind the mask with respect to the illumination source. The 75 cm×55 cm diffusing screen 130 is made of Grafix GFX clear vellum paper. The mask and screen are inserted between three sheets of 3 mm thick laminated safety glass 125. Any number of different interchangeable masks can be used, see FIG. 6. The sheets of glass ensure that the mask and diffusing screen are coplanar and in close proximity of each other, i.e., the separation is a small number of millimeters.

The sensor 140 is a single 8.0 megapixel digital camera. The sensor acquires a single image l 141 of the scene. The camera is coupled to a processor 150 that performs the method 800 as described herein. The processor includes memories, and input/output components as known in the art to perform the necessary computations.

To determine the 3D shape of the object 101, the camera records a single 3456×2304 pixel image 141. In one embodiment, the pinholes in the mask 120 are uniformly spaced at spatially resolution Nₓ=151 pixels, and an angularly resolution N₀=11 pixels. These values are described in greater detail below. This way the camera oversamples both the spatial and angular dimensions by a factor of two to conform with the Nyquist sampling theorem. If we substitute these design parameters and the physical dimensions of the system into Equation (14) below, then the distance between the masks and the diffusing screen behind the mask is approximately three mm in order to recover the shadowgrams produced by each of the LEDs.

Shield Fields

We describe volumetric occlusion using shield field analysis in a ray-space and the frequency-domain. For simplicity, we describe a 2D light field incident on a ID image plane, although this can easily be extended to 4D light field incident on 2D image plane. The incident light has a single wavelength and an occluder, e.g., the object 101, does not reflect or refract light.

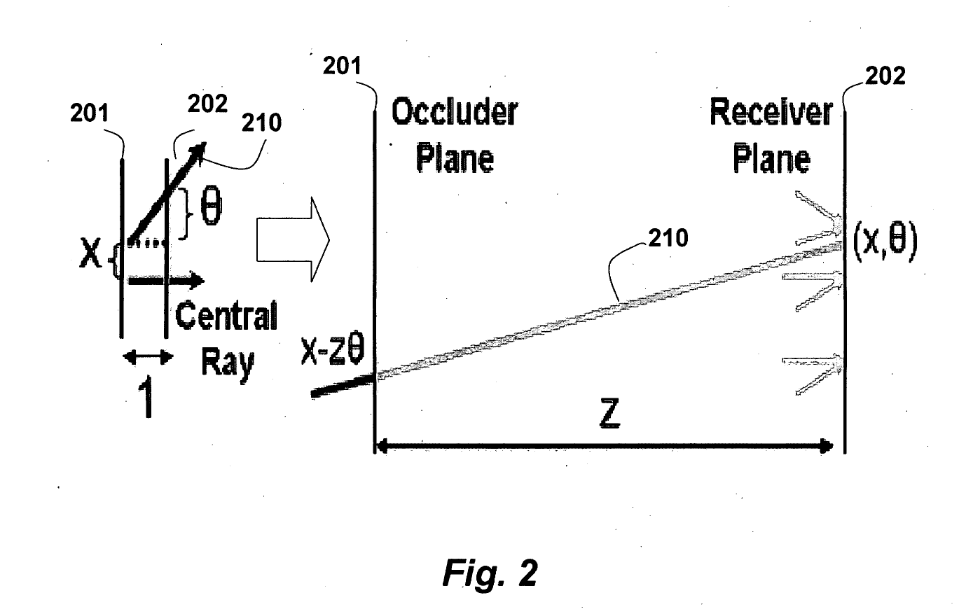

As shown in FIG. 2, the light field is parameterized using a two plane parametrization. A spatial dimension of a first plane 201 is x, and a position of intersection of an incident ray 210 with a second plane 202, which is parallel and an angular unit distance away from first plane is θ. In the absence of an occluder, the incident light field at the receiver plane is defined as l_{receiver}(x, θ).

Now consider an occluder 101 placed in front of the receiver plane.

In the absence of an occluder, the receiver plane records the incident light field l_{incidence}(x, θ). Assume that the occluder o(ζ), possibly a nonbinary attenuator, is located at another parallel occluder plane separated by a distance z in front of the receiver plane.

First, we determine the effect of this occluder on the incident light field. By tracing the light ray (x, θ) backwards, we find that the light ray intersects the occluderoplane at ζ=x−zθ. As a result, the received light field l_{receiver}(x, θ), in the presence of the occluder o(ζ), is given by the multiplication of incident light field by o(x−zθ).

In general, we define the shield field s(x, θ) as the attenuation function applied to the incident light field as

l_{receiver}(x, θ)=s(x, θ)l_{incident}(x, θ) (1)

For the case of equal attenuation as a function of incidence angle, the shield field for a planar occluder is s(x, θ)=o(x). In this case, we call o(ζ) a “Lambertian occluder” in analogy to the well-known example of Lambertian reflectors. The field quantifies the attenuation of each ray due to the occluding surfaces encountered along its path from the emitter to the receiver plane.

Physically, the shield field is the resultant light field due to an occluder (or multiple occluders for a general scene) when the incident illumination is uniform, i.e., all rays have equal radiance. Because the shield-field describes the 4D attenuation under uniform illumination, we find that it only depends on the spatial attenuation of the occluder. This allows the occluders and the light fields to be separated.

Planar Occluders

The spectral properties of the shield field is described using a frequency-domain analysis. We apply this analysis to design our light field camera system. 100 for acquiring the shield field, as well as to understand sampling issues related to our designs.

In the following description, the 2D Fourier transform of s(x, θ) is S(fₓ, f_{θ}). Where fₓ is the frequency in the spatial dimension x, and f_{θ} is the frequency in the angular dimension θ.

Occluder Plane

The shield field due to a planar occluder with an attenuation pattern o(ζ) at the occluder plane is s(x, θ)=o(x). This means that the shield field at the occluder plane is dependent on the spatial dimension x and is independent of the angular dimension θ. The Fourier transform concentrates all the energy in the spectrum O(fₓ) concentrated along the fₓ-axis, such that

S(fₓ, f_{θ})=O(fₓ)δ(f_{θ}), (2)

which vanishes for θ≠0. The Dirac delta function g is defined as:

δ(x)=1 for x=0 , δ(x)=0 otherwise.

Receiver Plane

At the receiver plane, s(x, θ)=o(x−zθ). By taking the 2D Fourier transform, we have

$$S ( {f}_{x} , {f}_{θ} ) = {\int }_{- ∞}^{∞} {\int }_{- ∞}^{∞} o ( x - z θ ) {e}^{- j {f}_{x} x} {e}^{- j {f}_{θ} θ} d x d θ , \qquad ( 3 )$$

where j=\sqrt{−1.}
Substituting u=x−zθ and v=θ, we have x=u+zv. By a change of the variables, the above integration yields

S(fₓ, f_{θ})=O(fₓ)δ(f_{θ}+fₓz). (4)

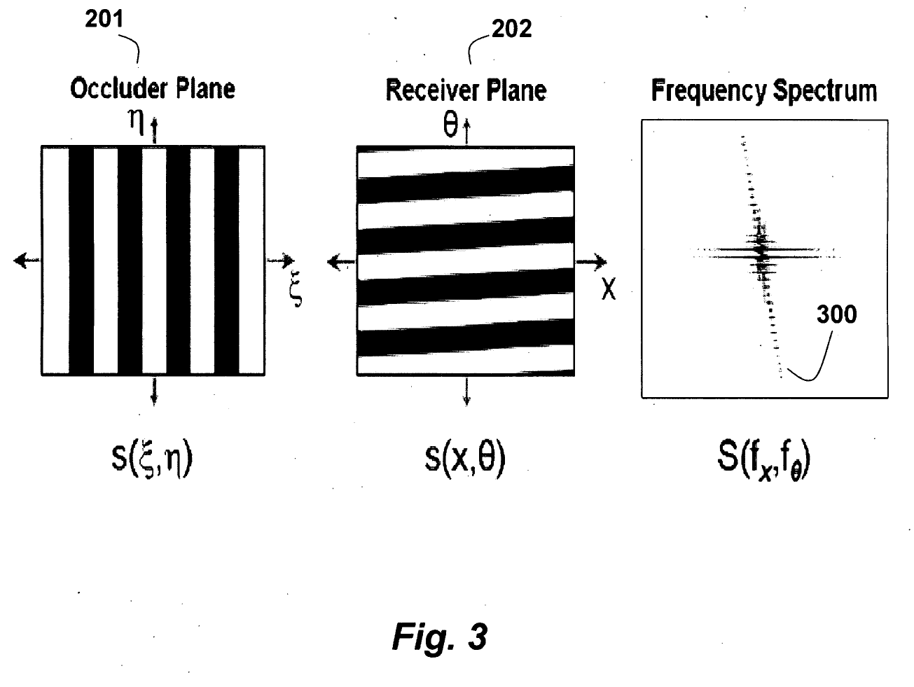

As shown in FIG. 3 for the occluder plane 201, the occlusion function o(ζ) is a square wave. At the occluder plane the shield field has lines parallel to θ, because the attenuation depends only on the spatial dimension. At the receiver plane, the lines remain parallel, but rotate depending on the distance z. The Fourier transform of the shield field concentrates on a line 301, and all the energy of the shield field spectrum at the receiver plane lies along a line given by f₀+fₓz=0. The slope of this line depends on the distance between the occluder and the receiver plane. If z=0, the line coincides with the fₓ-axis. At z=∞, this line coincides with the f₀-axis. As z increases from zero to infinity, the slope of the line increases froth 0 to π/2 radians.

General Occluders

We model general occluders. By general occluders, we mean any collection of semi-transparent or opaque objects at arbitrary positions in the scene 102. An analytic expression for the shield field for such a general scenario is difficult to derive. We select to approximate a general occluder using a set of planes parallel to the receiver plane. The effect of each of these planes can be analytically determined using the shield field equation for a single plane. The overall shield field can then be found as the product of the individual shield fields.

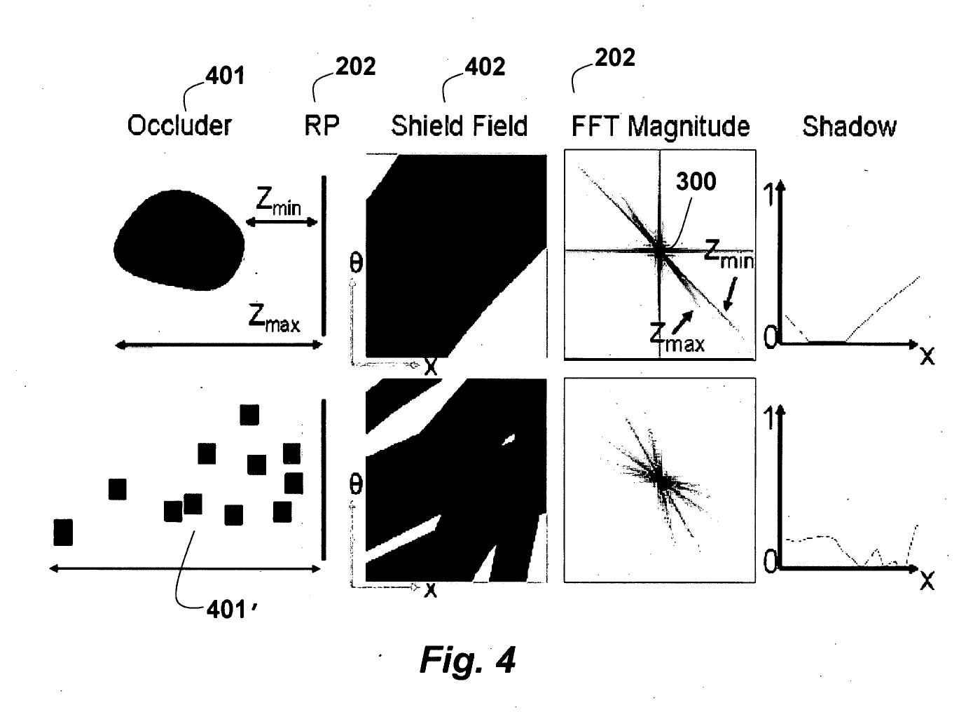

FIG. 4 shows the shadow functions corresponding to the shield fields for various occluder configurations. As shown in FIG. 4, the occluder 401 or occluders 401′ is located at a distance between zₘᵢₙ and zₘₐₓ from the receiver plane (RP). In this case, the spectrum of the shield field 402 lies between two slanted lines in the Fourier domain corresponding to zₘᵢₙ and zₘₐₓ. The shield field depends only on the shape of the occluder and its distance from RP. Also note that the Fourier transform of the shield field lies between two slanted lines depending on zₘᵢₙ and zₘₐₓ, i.e., a depth extent of the occluder).

We approximating the occluder (object) as a combination of k parallel planes at distances {z₁, . . . , zₖ}. The combined shield field s(x, θ), in the receiver plane coordinate system, is given by the product of the individual shield fields such that

$$s ( x , θ ) = {\prod }_{i = 1}^{k} {o}_{i} ( x - {z}_{i} θ ) . \qquad ( 5 )$$

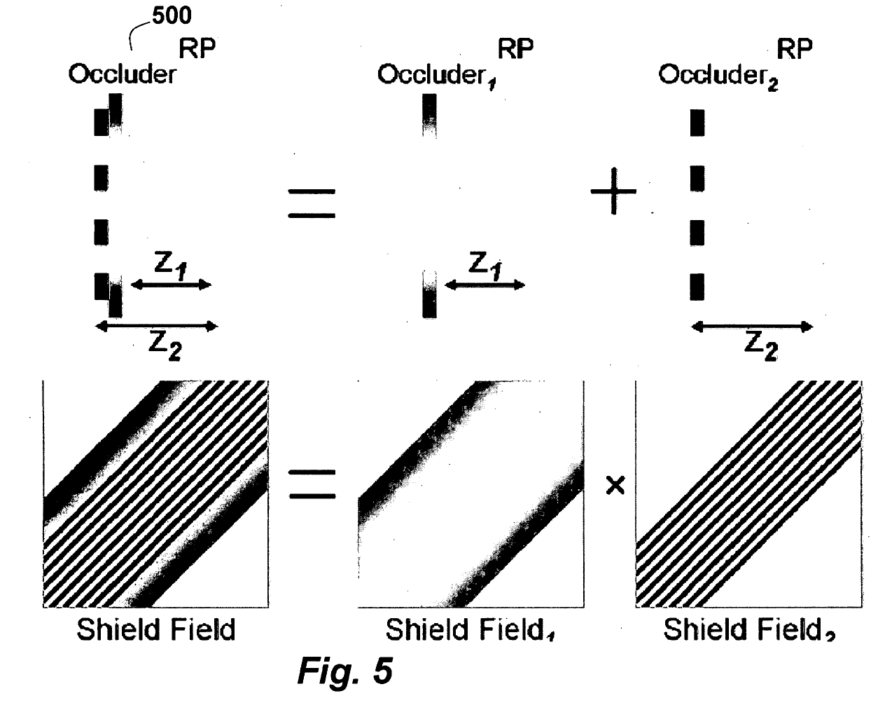

FIG. 5 shows this approximation, where a complex occluder is decomposed as two parallel and coincident planes. That is, a general occluder can be considered as a combination of several occluders at k parallel planes. FIG. 2 shows an occluder approximated as k=2 planes. The combined shield field at the receiver plane can be obtained by simply multiplying (x) the individual shield fields corresponding to each of the k planes.

In this example and in general, the combined Fourier transform of the shield field can be computed as a convolution of the Fourier transforms of the individual shield fields for each parallel plane in the approximation as

S(fₓ, f_{θ})=S₁(fₓ, f_{θ})*S₂(fₓ,f_{θ}) . . . *Sₖ(fₓ, f_{θ}) (6)

Modeling the Receiver Plane

When the surface of the receiver is planar, the silhouettes cast by the illumination source 110 are simply a projection of the received light field along the θ direction. This can be efficiently computed using frequency-domain techniques.

The Fourier slice theorem states that the ID Fourier transform of a projection of the 2D light field is equivalent to a 1D slice of its 2D Fourier transform. As a result, the cast silhouettes can be computed by evaluating a slice of the Fourier transform of the incident light field and computing its inverse Fourier transform.

In general, the receiver surface could be non-planar. For such surfaces, the silhouette is obtained as an integral of the shield field. The domain of the integral is dependent on the shape of the receiver surface. For specific surface configurations, we can evaluate these integrals numerically. Alternatively, arbitrarily complex receivers can be handled by another series of parallel planes.

Light Field Camera

In this section, we focus on acquiring shield fields using our shield field camera 100. The shield field camera is a light field camera and associated illumination source 110 optimized for acquiring images of silhouettes cast by a real-world object. After measuring the shield field for the object, we construct its visual hull 103 from a single measurement (image) to facilitate real-time visual hull applications.

One design for our shield field camera 100 is based directly on the above analysis. The single light field camera 140 is aimed at the scene 102 including the object 101. The scene is illuminated be the large area illumination source 110. In our system, the shield field s_{occluder}(x, θ) of the object 101 can be recovered using a calibration image taken without the occluder present in the scene. In this case, the camera directly records the incident light field l_{incident}(x, θ).

From Equation 1, we find that the shield field can be recovered by the light field of the occluder, l_{occluder}(x, θ), by the incident light field

$${s}_{occluder} ( x , θ ) = \frac{{l}_{occluder} ( x , θ )}{{l}_{incident} ( x , θ )} . \qquad ( 7 )$$

The incident light field should be non-zero for all sampled rays (x, θ). Therefore, we use the large area illumination source, which covers the field of view of the light field camera 140. We could also use a point light source array with one source per angular-sampling bin.

Our shield field system has two primary elements. A large-format light field camera 140 serves as the receiving surface. The receiver-to-object baseline l_{receiver} is about one meter. The area of the illumination source is larger than area of the receiving surface so that the field of view is filled. We use a large 2×2 m light box or a uniform array of point light sources lₑₘᵢₜₜₑᵣ (LEDs 111). If these surfaces are separated by a distance dₑₘᵢₜₜₑᵣ, about one meter, then we can acquire the shield field of objects of about half a meter in diameter or smaller.

One criterion for our camera is to achieve a very large receiver baseline. To discretely sample the shield field, we also desire a camera with easily-controllable spatial and angular sampling rates. In the prior art, camera arrays have been used to record large-baseline light fields and to construct visual hull models. We use a single-sensor camera to achieve similar baselines. Using a single camera eliminates calibration and synchronization issues inherent in multiple-camera systems.

Instead of using a lenslet array in front of the diffusing screen to form a uniform array of images, we use the attenuating mask 120. As an advantage a printed mask is relatively easy to make and can be scaled to arbitrarily large sizes.

Heterodyne Patterns

Up to now, only two types of attenuating patterns have been described for light field acquisition: uniform arrays of pinholes; and sinusoidal heterodyne patterns.

We adapt both of these patterns for our shield field camera. By applying the frequency-domain anal_{y}sis above, we generalize to form a broader class of equivalent tiled-broadband codes.

The family of patterns we describe is exhaustive and contains all possible planar attenuation patterns for mask-based light field cameras, one of which is a sum-of-sinusoids (SoS) pattern, or high frequency patterns.

Again for simplicity of this description, we use a 1D attenuation patterns for sampling 2D light fields. The generalization to 2D patterns for 4D light field acquisition follows directly from this analysis.

Pinhole Arrays

The planar occluder 101 is placed at a small distance dₚᵢₙₕₒₗₑ from the mask 120. In one embodiment, the mask includes uniformly spaced pinholes. A pinhole array occluder function oₚᵢₙₕₒₗₑ(ζ) is

$${O}_{pinhole} ( ξ ) = {\sum }_{k = - ∞}^{∞} δ ( ξ - {ka}_{0} ) ; \qquad ( 8 )$$

where α₀ is the distance between the pinholes and is selected to ensure that images from adjacent pinholes do not overlap. Thus,

$${a}_{0} = \frac{{d}_{pinhole} {l}_{emitter}}{{d}_{emitter}} . \qquad ( 9 )$$

In this configuration, the image behind each pinhole is a slightly different view of the,scene, thus sampling the spatial and angular variation of the incident light field. We apply a frequency-domain analysis to the pinhole array. The incoming light field is bandlimited to fₓ_{₀} and f_{θ}_{ₒ}.

From the Fourier slice theorem, the image at the sensor is a horizontal slice along f_{θ}=0 of the incident light field spectrum. In the absence of the mask, the ID sensor can only acquire a slice of the 2D light field spectrum. When the mask is included, the shield field sₚᵢₙₕₒₗₑ(x, θ) is

$$\begin{matrix}{s}_{pinhole} ( x , θ ) = {o}_{pinhole} ( x - {d}_{pinhole} θ ) \\ = {\sum }_{k = - ∞}^{∞} δ ( x - {d}_{pinhole} θ - {ka}_{0} )\end{matrix} \qquad ( 10 )$$

Thus, the Fourier transform of the pinhole array shield field is

$${S}_{pinhole} ( {f}_{x} , {f}_{θ} ) = {ω}_{0} {\sum }_{k = - ∞}^{∞} δ ( {f}_{x} - k {ω}_{0} ) δ ( {f}_{θ} + {f}_{x} {d}_{pinhole} ) ; \qquad ( 11 )$$

where ω₀=2π=a₀. The shield field spectrum at the receiving plane has a series of impulses along the line given by f_{θ}+fₓdₚᵢₙₕₒₗₑ=0. The overall effect of this shield field is to modulate the incident light field by generating spectral replicas at the center of each impulse. After the modulation, the sensor slice contains the information of the entire light field spectrum.

Sum-of-Sinusoids

Although pinhole arrays are sufficient for our application, they severely attenuate the incident light. This necessitates either a very bright source or long exposures, which could preclude real-time applications. However, from the above analysis, we recognize that any attenuation pattern can be used so long as the spectrum of its shield field is composed of a regular series of impulses.

One method to obtain alternative attenuation patterns evaluates a truncated inverse Fourier transform of the desired shield field spectrum Sₚᵢₙₕₒₗₑ(fₓ, f_{θ}) given by Equation 11. In this case, the following shield field results in modulation equivalent to the pinhole array, where Nₓ and N_{θ} are the desired sampling rates in the x and θ dimensions, respectively,

$${s}_{SoS} ( x , θ ) = 1 + {\sum }_{k = 1}^{( {N}_{0} - 1 ) / 2} 2 cos ( 2 π k {ω}_{0} ( x - {d}_{SoS} θ ) ) . \qquad ( 12 )$$

This shield field spectrum can be achieved by placing a “sum-of-sinusoids” (SoS) pattern at a distance d_{SoS} from the sensor, with an occlusion function

$${o}_{SoS} ( ξ ) = 1 + {\sum }_{k = 1}^{( {N}_{θ} - 1 ) / 2} 2 cos ( 2 π k {ω}_{0} ξ ) , \qquad ( 13 )$$

where the position of the mask is

$${d}_{SoS} = ( \frac{{f}_{{θ}_{R}}}{2 {f}_{{x}_{o}} + {f}_{{θ}_{R}}} ) {d}_{emitter} , \qquad ( 14 )$$

where fₓₒ=Nₓ=(2l_{receiver}) and f_{θR}=1=lₑₘᵢₜₜₑᵣ. This attenuation pattern is a summation of equal-phase sinusoidal functions with fundamental frequency ω₀ and (n-1)=2 harmonics.

Thus, our shield field analysis unifies previous light field acquisition methods and shows that the SoS mask is a natural extension of the pinhole array. The SoS pattern is significantly more efficient in terms of total transmission. In general, 2D SoS masks for 4D light field acquisition transmit about 18% of the incident light for angular resolutions of 11×11 pixels, or greater.

General Tiled-Broadband Patterns

While SoS patterns arc superior to pinholes, we recognize that they could still present limitations for our application. First, SoS patterns are continuous-valued functions. We considered printing such patterns using continuous-tone film recorders, such as the light valve technology (LVT) printing process. Commercial LVT printers typically provide prints up to approximately 25 cm×20 cm at 1,524 DPI. The we need to tile several printed patterns to achieve our desired sensor baseline dₛₑₙₛₒᵣ of about one meter. The primary commonality between pinhole arrays and SoS masks: they are both periodic functions.

Alternatively, we can use an equivalent heterodyne pattern with two primary properties: minimal attenuation; and associated commercial printing processes capable of producing seamless masks with widths in excess of one meter.

As a fundamental result for Fourier transforms, the spectrum of a continuous periodic function is composed of a set of discrete values given by its Fourier series. If we assume that the occlusion function for a single tile, defined by a periodic function of period T, is oₜᵢₗₑ(ζ, T), then the Fourier transform Otile(fζ, T) is

$$\begin{matrix}{O}_{tile} ( {f}_{ξ} ; T ) = {\int }_{- ∞}^{∞} {\int }_{- ∞}^{∞} {o}_{tile} ( ξ ; T ) {e}^{- j {f}_{ξ} ξ} d ξ \\ = {\sum }_{k = - ∞}^{∞} {O}_{tile} [ k ; T ] δ ( {f}_{ξ} - {kf}_{{ξ}_{0}} ) ;\end{matrix} \qquad ( 15 )$$

where f_{ζ0}=2π/T and the coefficients of the discrete Fourier series Oₜᵢₗₑ[k; T] are

$${O}_{tile} [ k ; T ] = \frac{1}{T} {\int }_{- T / 2}^{T / 2} {o}_{tile} ( ξ ; T ) {e}^{- j {kf}_{{ξ}_{o}} ξ} d ξ . \qquad ( 16 )$$

The spectrum of any periodic function is composed of a weighted combination of impulses. If we examine the coefficients Oₜᵢₗₑ[k; T] for the pinhole array and SoS functions, then we see that the coefficients are nearly constant for all k. In other words, the individual tiles for any heterodyne pattern should be broadband. In addition, because all mask functions must be positive, real-valued functions we conclude that the number of coefficients in this series is be equal to (N_{θ}−1)/2, where N_{θ} is the desired angular resolution.

If this condition is satisfied using Equation (15) below, then the shield field produced by the mask is always equivalent to a pinhole array, up to a known phase shift. In addition, a general broadband code can be placed at the same distance from the sensor as a SoS code and having an equal period.

After we determine the general property for all heterodyne masks, we can find a pattern, which achieves minimal attenuation, and that can be produced using large-format printing processes. In general, binary patterns are easier to print. For instance, commercial printers used for photolithographic printing are capable of producing 5,080 DPI transparencies up to 70 cm×50 cm.

Modified uniformly redundant array (MURA) patterns are well-known binary broadband codes, which have been used in astronomical and medical imaging. MURA patterns transmit approximately 50% of incident light. This reduces exposure time by a factor of about 2.7 when compared to SoS patterns.

The patterns are known to be equivalent to a pinhole aperture in x-ray imaging. We recognize that a tiled array of such patterns can also approximate a tiled array of pinholes. This conclusion is non-trivial. We emphasize that our unifying theory of shield fields and tiled-broadband codes has led us to this recognition.

We define the specific tiled-MURA attenuation pattern used in our system. The two-dimensional MURA occlusion function of prime-dimensions p×p is

$${o}_{MURA} [ n , m ] = \{ \begin{matrix}0 & if n = 0 , \\ 1 & if n \neq 0 and m = 0 , \\ 1 & if {C}_{p} [ n ] {C}_{p} [ m ] = 1 , \\ 0 & otherwise ,\end{matrix} \qquad ( 17 )$$

where (n, m) are the orthogonal pixel coordinates in the mask plane, and Cₚ[k] is the Jacobi symbol

$${C}_{p} [ k ] = \{ \begin{matrix}1 & if ∃ x , 1 \leq x < k , s . t . k = {x}^{2} ( mod p ) , \\ - 1 & otherwise .\end{matrix} \qquad ( 18 )$$

Unlike SoS or pinhole patterns, MURA patterns can only be used when the angular resolution p=N_{θ} is a prime number. The tiled-MURA pattern provides an optimal attenuation pattern, in terms of total light transmission, for both our application as well as general heterodyne light field acquisition. MURA patterns provide significantly less attenuation than other codes, while using lower-cost and more-scalable printing processes.

FIG. 6 shows some example masking patterns at various resolutions, with black and white inverted for clarity.

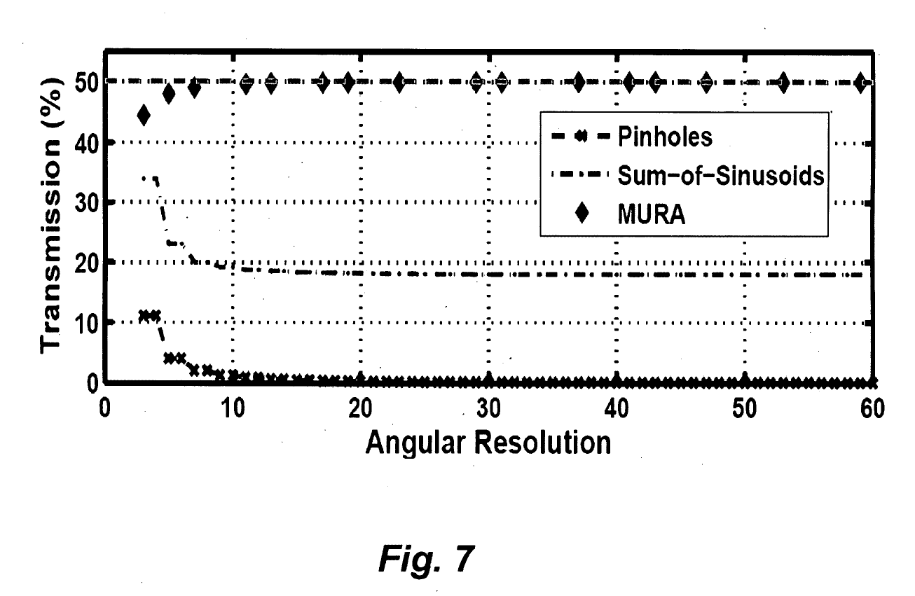

FIG. 7 compares the mean transmission as a function of angular resolution for the various patterns shown in FIG. 6. The SoS tiles converges to about 18% transmission for large angular resolutions. In contrast, tiled-MURA codes remain near 50% transmission for any angular resolution desired. As a result, exposure times with MURA tiles is about 2.7 times less than the equivalent SoS mask.

Visual Hulls from Shield Fields

To construct the 3D visual hull 103 of the object 101, we decode the image of diffusing screen using our heterodyne decoding method 800. This produces an estimate of the incident light field. For sufficiently-large angular sampling rates, each sample along the emitter surface corresponds to a small area source. Each 2D slice of the 4D light field for a constant angular resolution element contains the individual shadowgram produced by each emitter element.

Unfortunately, the diffusing screen limits our angular resolution to approximately 11×11 pixels. For this reason, better results can be obtained if the illumination source 101 is uniform array of point light sources 111. A single light field image now contains shadowgrams 131 produced by each point light source with minimal crosstalk between neighboring angular samples. Our solution effectively solves a key limitation of previous shape-from-silhouette systems, which only use a single point source for a given image.

As shown in FIG. 8, the 3D shape 103 of the object 101 can be determined using our shape-from-silhouette 3D reconstruction method 800.

The sensed light field in the image 141 is partitioned 810, according to the silhouettes, into N individual shadowgrams or subviews {l₁(u₁), . . . , l_{N}(u_{N})) 811, where uⱼ is a pixel in the j^{th} subview and lⱼ(uⱼ) is a normalized image intensity.

A projection equation for each subview is uⱼ=πⱼ(q), which for a 3D point q within the reconstruction volume, maps q to a position in the j^{th} subview.

Using space carving, each subview lⱼ(uⱼ) is segmented 820 to a obtain corresponding a binary image pⱼ(uⱼ) 821. The segmentation can also use other “methods such as clustering, region growing, and probabilistic methods that represent. The space carving approach generates an initial reconstruction that envelops the object to be reconstructed. The surface of the reconstruction is then eroded at the points that are inconsistent with the input images. In each binary image, each point q contained within the object is pₖ(π(q))=1. If pⱼ(uⱼ)=0, then none of the 3D points q for which πj(q)=uⱼ are in the object. Because this is true for j={1, . . . , N), we find p(q)=1 for every point q in the object, where

$$p ( q ) = {\prod }_{j = 1}^{N} {p}_{j} ( {π}_{j} ( q ) ) . \qquad ( 19 )$$

A condition for a point q to be outside of the object is that one of the factors in this product is zero. Having multiple binary images is sufficient to recover the visual hull. Therefore, the visual hull 103 of the object 101 can then constructed 850 according to the isosurfaces of the binary images.

However, because our subviews have a low resolution, the thresolding operation could eliminate useful information about the 3D shape of the object contained in the normalized image intensity. Therefore, we can optionally set each pixel pⱼ(uⱼ)=lⱼ(uⱼ) and regard p(q) as a probability density function representing the pixel. If the probability p(q) is small, then it is very likely that the pixel q is outside the object.

Our image may have a varying signal-to-noise (SNR) ratio due to the diffusing construction of screen. To reduce this SNR ratio, we can optionally also estimate 830 a confidence images cⱼ(uⱼ) 831, using probabilistic methods and a calibration light field image 832 acquired without the object in the scene, so that cⱼ(uⱼ)≅1 for high-SNR pixels and cⱼ(uⱼ)≅0 for low-SNR pixels.

Then, we form 840 a confidence-weighted probability density function (PDF) 841

$${p}^{′} ( q ) = {\prod }_{j = 1}^{N} {p}_{j}^{′} ( {π}_{j} ( q ) ) = {c}_{j} ( {u}_{j} ) {p}_{j} ( {u}_{j} ) + ( 1 - {c}_{j} ( {u}_{j} ) ) . \qquad ( 20 )$$

The visual hull 103 of the object 101 in this refinement is then constructed 850 according to the isosurface of the probability density function.

Analysis

We describe effects due to discretely sampling shield fields. We consider the shield field s₀(x, y) as a function of two coordinates associated with parallel planes, with the y-coordinate on the emitter plane and the x-coordinate on the receiver plane. The change of variables s(r, θ)=s₀(x, y) is given by the relation dₑₘᵢₜₜₑᵣ θ=x−y.

We consider an occluder plane arranged parallel to and between the emitter and receiver planes at a distance z from the receiver plane, with a sinusoidal attenuation pattern o(ζ)=cos(ω ζ) of angular frequency !=2πf.

First, we consider impulse sampling for a discrete shield field defined as

s[n, m]=s′(nΔx, mΔy),

where n and in are integers, Δx is the receiver plane sampling period, and Δy is the sampling period in the emitter plane.

In the continuous domain, we have

s′(x, y)=o(x−σ(x−y))=cos(ω(1−σ)x+ωσy) (21)

resulting in

s[n, m]=cos(|ω(1−σ)Δx]n+[ωσΔy]m). (22)

The Nyquist sampling theorem requires that we samples at least twice per cycle to avoid aliasing. This leads to two inequalities

ω(1−σ)Δx<π and ωσΔy<π.

From these constraints, we find that the minimum wavelength that can be recovered, at a depth z, is

Tₘᵢₙ=2 max{(1−σ)Δx, σΔy}. (23)

A more realistic model for the sampling process can be achieved using integral sampling, where

$${s}^{′} [ n , m ] = \frac{1}{Δ x Δ y} {\int }_{( n - \frac{1}{2} ) Δ x}^{( n + \frac{1}{2} ) Δ x} {\int }_{( m - \frac{1}{2} ) Δ y}^{( m + \frac{1}{2} ) Δ y} s ( x , y ) d x d y . \qquad ( 24 )$$

In this case, a straightforward derivation yields

$${s}^{′} [ n , m ] = s [ n , m ] \frac{sin ( ω ( 1 - σ ) Δ x / 2 )}{( ω ( 1 - σ ) Δ x / 2 )} \frac{sin ( ω σ Δ y / 2 )}{( ω σ Δ y / 2 )} , \qquad ( 25 )$$

where s[n, m] is the expression for the impulse sampling derived above.

If the angular frequency w satisfies the impulse sampling constraints, then these two additional factors can be compensated for because they are always non-zero. This results in the same constraint on the minimum wavelength as in the impulse sampling case.

After correcting for lens distortion in the camera, the primary system limitations arise from the diffusing screen 130. Due to its design, the diffusing screen 130 has some amount of subsurface scattering and increases the point spread function (PSF) of the system. We estimate that this PSF has a half-width of approximately 300 μm at the diffuser plane corresponding to a 1.4×1.4 pixel region within the recorded image.

Because the sheets of glass 125 cannot be made perfectly flat, the distance between the mask and diffuser varies slowly across the image. The low-frequency variations within the subviews arise from this limitation and also lead to addition crosstalk between neighboring subviews.

We could reduce these effects by recording a calibration image for each point light source 111. Instead, we allow our visual hull procedure to reject pixels with low-confidence in the shadowgram estimates.

### Effect of the Invention

To the best of our knowledge, our invention provides the first single-camera, single-shot approach to generating visual hulls.

Our method does not require moving or programmable illumination. Shield fields as defined herein can be utilized for numerous practical applications, including efficient shadow computations, volumetric and holographic masks, and for modeling general ray-attenuation effects as 4D light field transformations.

Although the invention has been described with reference to certain preferred embodiments, it is to be understood that various other adaptations and modifications can be made within the spirit and scope of the invention. Therefore, it is the object of the append claims to cover all such variations and modifications as come within the true spirit and scope of the invention.

We claim:

1. An apparatus for determining a 3D shape of an object in a scene, comprising:
an illumination source;
a mask, wherein the object is arranged in the scene between the illuminating source and the mask;
a diffusing screen, wherein the diffusing screen is coplanar and in close proximity to the mask, and the diffusing screen is behind the mask with respect to the light source;
a sensor configured to acquired a single image of the diffusing screen while the object is illuminated by the illuminating source to cast multiple silhouettes on the diffusing screen;
means for partitioning the image into subviews, wherein each subview includes one of the multiple silhouettes; and
means for constructing a visual hull of the object according to silhouettes in the subviews, wherein the visual hull approximates the 3D shape of the object.

2. The apparatus of claim 1, wherein the illuminating source includes an array of point light sources.

3. The apparatus of claim 1, wherein the illuminating source emits a high frequency illumination pattern.

4. The apparatus of claim 1, wherein the mask is printed on a polyester base.

5. The apparatus of claim 1, wherein the mask includes a pattern of pinholes.

6. The apparatus of claim 1, wherein the mask includes a sum-of-sinusoidal heterodyne pattern or any other continuous pattern resulting in impulses in a frequency domain.

7. The apparatus of claim 1, wherein the mask includes any binary pattern resulting in impulses in a frequency domain.

8. The apparatus of claim 1, wherein the binary pattern is a tiling of a modified Uniformly redundant array code.

9. The apparatus of claim 1, wherein the diffusing screen is made of clear vellum paper.

10. The apparatus of claim 1, wherein a distance between the mask and the diffusing screen is about 3 millimeters.

11. The apparatus of claim 1, wherein a distance between the mask and diffusing screen is based on a desired angular and spatial resolution of a shield fields.

11. The apparatus of claim 1, wherein the sensor is a digital camera.

12. The apparatus of claim 5, wherein the pinholes are uniformly spaced at a spatially resolution and an angularly resolution.

13. The apparatus of claim 1, wherein the illuminating source is a light box having an area that is larger than an area of the diffusing screen.

14. The method of claim 1, wherein the constructing further comprises:
means for thresholding each subview to obtain a corresponding binary image; and
means for constructing the visual hull of the object according to isosurfaces of the binary images.

15. A method for determining a 3D shape of an object in a scene, comprising:
illuminating the object in the scene to casts multiple silhouettes on a mask and diffusing screen coplanar and in close proximity to the mask, and wherein the diffusing screen is behind the mask with respect to the illuminating source;
acquired a single image of the diffusing screen;
partitioning the image into subviews according to the silhouettes; and
constructing a visual hull of the object according to silhouettes in the subviews, wherein the visual hull approximates the 3D shape of the object.

16. The method of claim 15, wherein the constructing further comprises:
thresholding each subview to obtain a corresponding binary image; and
constructing the visual hull of the object according to isosurfaces of the binary images.

17. The method of claim 15, wherein the mask includes a pattern of pinholes.

18. The method of claim 15, wherein the mask includes a sum-of-sinusoidal heterodyne pattern or any other continuous pattern resulting in impulses in frequency domain.

19. The method of claim 15, wherein the mask includes a binary broadband pattern.

20. The method of claim 15, wherein pixels in each image are represented by a probability density function.
